(19) United States
(12) Patent Application Publication
(10) Pub. No.: US 2015/0170298 A1
(43) Pub. Date: Jun. 18, 2015

(54) FUELING METHOD USING WIRELESS COMMUNICATION

(71) Applicant: Kyoung-Su PARK, Suwon-si Gyeonggi-do (KR)

(72) Inventor: Kyoung-Su Park, Suwon-si (KR)

(21) Appl. No.: 14/414,908

(22) PCT Filed: Jul. 15, 2013
(86) PCT No.: PCT/KR2013/006304

§ 371 Date: Jan. 15, 2015

(30) Foreign Application Priority Data
Jul. 16, 2012 (KR) 20-2012-0006278
Aug. 26, 2012 (KR) 10-2012-0093360
Nov. 28, 2012 (KR) 10-2012-0135932

(51) Int. Cl. G06Q 50/06; G06Q 20/32

(52) U.S. Cl. CPC G06Q 50/06; G06Q 20/325

(57) ABSTRACT

The present invention relates to a fueling method using wireless communication and a fueling system thereof. To this end, the present invention provides the fueling method wherein a wireless terminal can select at least one of information on kinds of oils, price information, payment information, and oil feeder information, can store the selected information on kinds of oils, price information, and payment information, can wirelessly transmit, to the selected oil feeder or the fueling system, the information on kinds of oils, price information, and payment information when accessing an oil feeder area or a fueling system area, and the oil feeder or the fueling system automatically sets the fueling on the basis of the information on kinds of oils, price information, and payment information.

### TECHNICAL FIELD

The present invention relates to a fueling method using wireless communication and a fueling system for the same.

### BACKGROUND ART

When a filling station attendant or a customer feeds fuel, by erroneously selecting an oil kind and a price, fuel mixing or miscalculation may occur.

Further, upon feeding fuel, if using an existing mobile payment method only when paying with a credit card, no difference exists in a mobile payment method, compared with an existing credit card payment method, but a payment time and a payment method are complex, compared with an existing credit card payment method and thus a customer may not prefer the mobile payment method.

A method of scanning a product with a bar code using an existing mobile device and paying with the mobile device at a payment counter and technology that can select a product such as coffee when visiting a specific store such as a coffee shop and that can request payment at the coffee shop have existed, but such products may be selected according to a person's preference and habit and a menu of a member store, and even if the product is erroneously selected, the product may be returned or exchanged, but when fueling is erroneously selected or when fueling of a wrong price is performed, a vehicle may be seriously damaged due to fuel mixing and thus as a payment method, whenever feeding fuel, a method of determining of a fueling oil kind and a fueling price on the spot has a danger element, and in a case of another product, when setting a product with a mobile device and when visiting a member store that sells a corresponding product, there is no reason that the corresponding product should be not automatically selected and paid, but in order to drive a vehicle, a corresponding fuel kind should be selected and payment should be performed, and until the vehicle is changed, there is specialty that the fuel product cannot be changed.

It is expected that methods of setting an oil kind and a price to feed fuel at a mobile device and transferring information set at the mobile device to a self oil feeder will be actually used due to such specialty. When a person uses an existing self oil feeder, in a state in which the person directly selects an oil kind and price to feed fuel, a signal about a fueling oil kind and a fueling price may be transmitted from the mobile device to the self oil feeder. In such a case, as a problem that two oil kinds and prices to feed fuel are different occurs, when the person feeds fuel, confusion may occur or a situation that cannot perform fueling may occur.

### DETAILED DESCRIPTION OF INVENTION

### Technical Problem

When a filling station attendant or a customer feeds fuel, by erroneously selecting an oil kind and a price, fuel mixing or miscalculation should not occur.

Further, upon feeding fuel, when paying with an existing mobile device, a total fueling time and customer's convenience should be provided, compared with paying with a credit card.

At a normal time, after fueling is set with a mobile device at one time, when fueling is applied to an oil feeder, if fueling to a vehicle that can be automatically set is performed, by enabling a fueling oil kind and a fueling price to be previously set to a mobile device, when feeding fuel, the mobile device should provide a function as a safety device that prevents fuel mixing or miscalculation of a fueling price from occurring.

In a mobile electronic device, by previously setting and storing a fueling oil kind and a content related to fueling, in a process of setting fueling in a filling station in real time, a problem that may occur when a person erroneously performs fuel mixing or a person erroneously knows and sets a fueling price should be solved, and the filling station should be automatically recognized without separately setting, and even if a separate oil feeder is not set, fueling should be performed from an oil feeder adjacent to a location at which a customer stops a vehicle.

When using a self oil feeder, a method of conveniently applying to the self oil feeder with a mobile device should be provided.

### Technical Solution

In accordance with an aspect of the present invention, a method of automatically fueling using wireless communication in a system comprising a wireless terminal and an oil feeder and a fueling system that receive a wireless signal from the wireless terminal includes: selecting at least one of oil kind information, price information, payment information, and oil feeder information in the wireless terminal and storing the selected at least one oil kind information, price information, and payment information; transmitting, by the wireless terminal, the at least one oil kind information, price information, and payment information to the selected oil feeder or the fueling system by wireless, when the wireless terminal approaches an oil feeder or fueling system area; and automatically fueling setting to the oil feeder or the fueling system based on the oil kind information, price information, and payment information.

### Advantageous Effects

In an oil feeder system that sets and receives a fueling oil kind and a fueling price based on a method and a configuration of the present invention, when using a mobile device, by enabling an oil feeder to operate without separate setting of a fueling oil kind and a fueling price, a mistake of fuel mixing or setting of a wrong price can be reduced, and an entire fueling setting time can be reduced, compared with when paying a fueling price using a credit card, and in this case, it is unnecessary that a customer performs separate setting to the oil feeder and thus the method is convenient and fuel mixing can be prevented from occurring by fueling a wrong oil kind and the method has stability.

When using a self oil feeder, a method of conveniently applying to the self oil feeder with a mobile device can be provided.

### BRIEF DESCRIPTION OF DRAWINGS

FIG. 1 is a block diagram illustrating a process in which a terminal transmits fueling information and payment information to an oil feeder and performs payment according to an exemplary embodiment of the present invention.

FIG. 2 is a block diagram illustrating a method of processing in a filling station system when a value set in an oil feeder and a value transmitted from a terminal are different according to another exemplary embodiment of the present invention.

FIG. 3 is a block diagram illustrating a method of processing when a value set in an oil feeder and a value transmitted from a terminal are different according to another exemplary embodiment of the present invention.

FIG. 4 is a block diagram illustrating next step to jump from standby step according to an exemplary embodiment of the present invention.

FIG. 5 is a block diagram illustrating a fueling method of using a POS system according to an exemplary embodiment of the present invention

FIG. 6 is a block diagram illustrating a fueling setting method of using a POS terminal in a non-self filling station according to an exemplary embodiment of the present invention.

### BEST MODES FOR CARRYING OUT THE INVENTION

Hereinafter, exemplary embodiments of the present invention will be described in detail with reference to the attached drawings such that the present invention can be easily put into practice by those skilled in the art. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

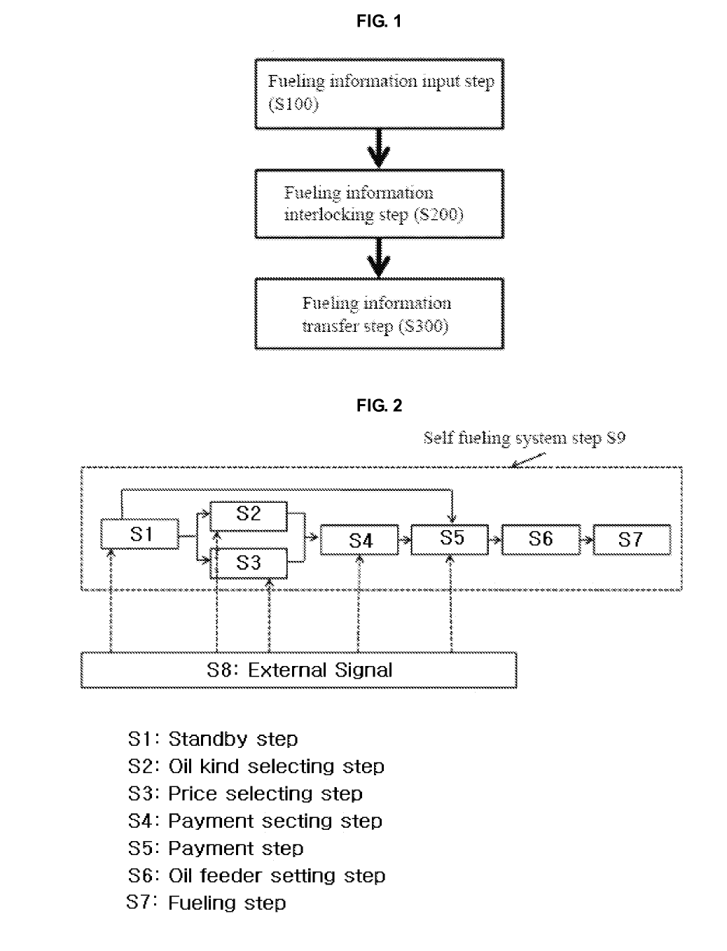

FIG. 1 is a block diagram illustrating a process in which a terminal transmits fueling information and payment information to an oil feeder and performs payment according to an exemplary embodiment of the present invention.

Referring to FIG. 1, the terminal provides a screen so that a user inputs information about an oil kind to feed fuel to a user vehicle, fueling price information, payment information, oil feeder information, and filling station information, and the user may select the fueling oil kind information, the fueling price information, the oil feeder information, and the filling station information on the screen (S100).

Information including at least one of the fueling oil kind information, fueling price information, payment information, oil feeder information, and filling station information (hereinafter, fueling information) selected in this way may be stored at the terminal and may be automatically provided to a corresponding oil feeder or a Point Of Sales (hereinafter, POS) system within a filling station connected to the corresponding oil feeder. In this case, fueling information provided to the oil feeder or the fueling POS system may be transmitted using a public mobile communication network of a long distance or using an NFC protocol such as Near Field Communication (NFC).

Alternatively, information including at least one of the selected fueling oil kind information, fueling price information, payment information, oil feeder information, and filling station information may be stored at the terminal in a form such as a character code, a bar code, or a QR code, the stored character code, bar code, or QR code may be displayed on a terminal screen and may be automatically transferred to a corresponding oil feeder or a fueling POS system using a communication protocol such as infrared ray. In this case, the corresponding oil feeder or the corresponding fueling system may receive a scan signal such as a character code, a bar code, or a QR code displayed on the terminal through a communication protocol of an infrared ray method, and the terminal may receive and again determine a scan result thereof from the corresponding oil feeder or the corresponding fueling system.

Alternatively, when the user selects fueling standby on the terminal, the set fueling information may be displayed and the screen may be provided to adjust at least a fueling item of thereof.

A fueling oil kind and a fueling price selected at the fueling information input step S100 may be interlocked with together selected payment information, be stored at the terminal, and then be automatically transmitted to the fueling system by a user selection or when entering a fueling zone (S200, S300).

At least one of the selected fueling oil kind, fueling price, payment information, and oil feeder information may be interlocked with a subscriber identity module chip (USIM chip), an NFC chip, and an RFID chip of a credit card installed and independently existing within the terminal and that can be connected to a corresponding terminal and may be stored.

Here, in a method of storing the information to interlock with payment information, when the payment information is transferred to the fueling system, it is preferable that a fueling oil kind and a fueling price are interlocked to be automatically transferred while the payment information is transferred, but at least one of payment information, a fueling oil kind, and a fueling price is first transferred to the fueling system, and then when the payment information, fueling oil kind, and fueling price that are not transferred are transferred to the filling station system, it may be regarded that the fueling oil kind and the fueling price are interlocked with the payment information.

Further, as a method of interlocking the information with payment information, when the terminal stores the information so that payment information, a fueling oil kind, and a fueling price transfer to the filling station system, it may be regarded that the fueling oil kind and the fueling price are interlocked with the payment information, and when payment information, a fueling oil kind, and a fueling price are not transferred to the filling station system, even if the filling station system requests the fueling oil kind and the fueling price, the fueling oil kind and the fueling price cannot be transferred to the filling station and thus when the fueling oil kind and the fueling price are stored at the terminal so as to transfer to the filling station system, it may be regarded that the fueling oil kind and the fueling price are interlocked with payment information.

After the fueling information interlocking step S200, instead of transmitting and receiving to and from a specific oil feeder and the terminal without information about a specific oil feeder, when the filling station system and the terminal transmit and receive or when the oil feeder does not automatically set a fueling oil kind and a fueling price, as an error occurs in the oil feeder, in the fueling system, a screen having a predetermined menu is provided to the terminal so that the terminal may identify or select the oil feeder. When the user selects the oil feeder on a corresponding screen, information of the oil feeder, payment information, and a fueling oil kind and a fueling price interlocked with the payment information are transferred to the filling station system (S300).

The terminal may scan an identifier, a bar code, and an image (QR code) displayed on the screen of the oil feeder and designate a corresponding oil feeder, the user may select a corresponding oil feeder with reference to a layout view of the oil feeder disposed within the filling station provided from the filling station system, and a number or a code attached to the oil feeder, and the user may directly input the number or the code attached to the oil feeder.

The present invention may be not applied to only fueling of a filling station but may provide a fuel setting system of a terminal that can select fuel to charge when selecting a fueling oil kind even in a gas station or an electric charging point that can feed fuel to a vehicle and that can set a price of the selected fuel and that can set desired fuel and a desired price using a wireless function of the terminal when paying a price for fueling like the filling station.

### MODES FOR CARRYING OUT THE INVENTION

FIG. 2 is a block diagram illustrating a method of processing in a filling station system when a value set in an oil feeder and a value transmitted from a terminal are different according to another exemplary embodiment of the present invention.

Referring to FIG. 2, a fueling system may include standby step S1 of standing by fueling before setting fueling, oil kind selecting step S2 of selecting an oil kind to feed fuel, price selecting step S3 of selecting a price to feed fuel, payment selecting step S4 of selecting at least one payment means of a plurality of payment means, payment step S5 of accepting payment based on the selected payment means, oil feeder setting step S6 of setting a corresponding oil feeder to feed fuel to a corresponding vehicle after payment is accepted, and fueling step S7 of feeding fuel to the vehicle. In this case, at each step from standby step to fueling step, it may be controlled whether to apply an external signal (at least one information of fueling oil kind information, fueling price information, oil feeder information, filling station information, and payment information necessary for fueling may be received from the corresponding terminal) transmitted from a corresponding terminal to each step.

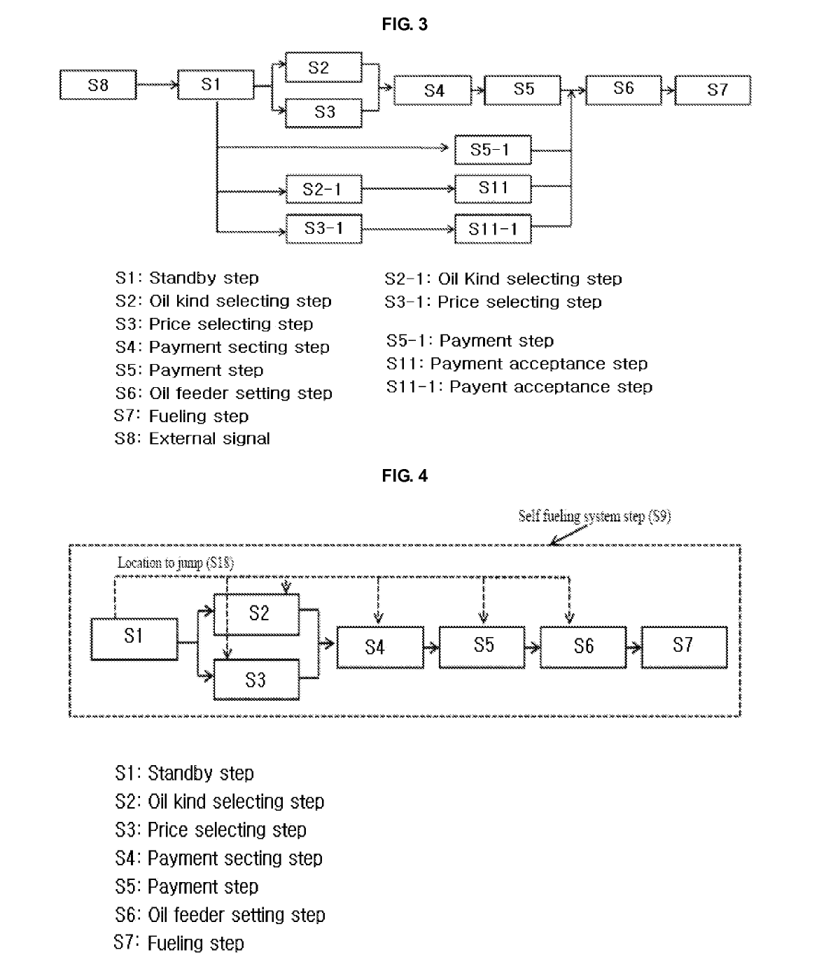

FIG. 3 is a block diagram illustrating a method of processing when a value set in an oil feeder and a value transmitted from a terminal are different according to another exemplary embodiment of the present invention.

Referring to FIG. 3, a fueling system may include standby step S1 of standing by fueling before setting fueling, oil kind selecting step S2 of selecting an oil kind to feed fuel, price selecting step S3 of selecting a price to feed fuel, payment selecting step S4 of selecting at least one payment means of a plurality of payment means, payment step S5 of accepting payment based on the selected payment means, oil feeder setting step S6 of setting a corresponding oil feeder to feed fuel to a corresponding vehicle after payment is accepted, and fueling step S7 of feeding fuel to the vehicle.

The filling station system determines whether at least one information (hereinafter, an external signal) of fueling oil kind information, fueling price information, and payment information transmitted from the terminal exists before standby step S1, oil kind selecting step S2, and price selecting step S3 (S8). If at least one information (hereinafter, an external signal) of fueling oil kind information, fueling price information, and payment information transmitted from the terminal exists (S5-1), the filling station system performs payment step S5-1 using payment information via standby step S1. Thereafter, the corresponding oil feeder automatically sets fueling information and provides fuel to the corresponding vehicle (S7). Alternatively, by notifying a filling station attendant that fueling information is setting, the filling station attendant may enable to provide fuel to the corresponding vehicle. If at least one information (hereinafter, an external signal) of fueling oil kind information, fueling price information, and payment information transmitted from the terminal does not exist, the filling station system may enable the terminal user to select oil kind information and price information while maintaining standby step S1 or while performing oil kind selecting step S2 and price selecting step S3.

However, when any one of these information is not transmitted or even if any one of these information is transmitted, when an error has occurred in a transmitting process, standby step S1 is maintained or by advancing to oil kind selecting step S2 and price selecting step S3, a screen is provided so that a corresponding terminal may select an oil kind or a price. Thereafter, payment acceptance step S5 is performed using payment information based on the selected payment means. Thereafter, by entering oil feeder setting step S6 and fueling step S7, a corresponding oil feeder automatically sets fueling information and provides fuel to the corresponding vehicle. Alternatively, by notifying the filling station attendant that fueling information is set, the filling station attendant may provide fuel to the corresponding vehicle.

If oil kind information and price information exist and separate payment information does not exist at an external signal provided at the standby step S1, payment information may be estimated from the oil kind information and price information. In this case, necessary information is referred to as an identification code, and the identification code may be a corresponding terminal self or an IP address and a phone number provided from a user of a corresponding terminal. The process advances from the standby step S1 to payment step S5-1, and at payment step S5-1, even if payment information does not exist, by analyzing the identification code or by transmitting the identification code to another server or the POS system, acceptance and a signal that fueling is available may be received.

When oil kind information, price information, and payment information does not exist at an external signal provided at the standby step S1, payment information of the terminal user or the terminal may be estimated based on oil kind information or price information through oil kind selecting step S2-1 and price selecting step S3-1. Payment acceptance steps S11 and S11-1 may be performed based on the estimated payment information.

The oil kind selecting step S2 and price selecting step S3 may be simultaneously or sequentially performed. The entire or at least one of the fueling oil kind information, fueling price information, and payment information exists to estimate another information. For example, the fueling oil kind information and the fueling price information may be estimated based on the payment information. The payment information may include information for credit providing in the fueling system.

A payment method at the payment selecting step S4 may select at least one of a credit card, cash, credit transaction, and mobile payment, and when the payment method is mobile payment, oil kind information, price information, and payment information provided from the terminal may be maintained or adjusted in the fueling system, and in this case, maintenance and adjustment may be provided by a program constituting the fueling system.

In the present invention, it is preferable that standby step is step before a person directly selects an oil kind and a price of an oil feeder, and when the oil feeder implements another additional function in addition to a function of selecting a fueling oil kind and a fueling price before selecting a fueling oil kind and a fueling price, it may be referred to as standby step, and a preferable example of an additional function may be advertisement at a self fueling monitor.

In the foregoing description, the filling station system may previously receive and store fueling oil kind information, price information, and payment information from a corresponding terminal before standby step S1 and block information to be added or changed from a corresponding terminal at oil kind selecting step S2, price selecting step S3, and payment selecting step S4, thereby avoiding confusion of the terminal user or a filling station attendant while a fueling process.

At payment step S5, except for oil kind selecting step S2 and price selecting step S3, the filling station system may enable to receive additional or change information from the corresponding terminal, and in this case, the filling station system may enable automatically payment information to be transferred to the fueling system using an NFC protocol such as NFC.

An external signal may be transferred from the terminal to the filling station system through a base station, i.e., a mobile communication network, and a signal may be directly transferred from the terminal to a communication device, a server, and a POS SYSTEM within the filling station without through the base station.

In the present invention, it is preferable that payment information is information that can accept an oil kind and a price to feed fuel, and when a credit transaction is performed in the filling station, information that may receive acceptance of the credit transaction, information that can request automatic withdrawal to a bank account, payment of a cost corresponding to a payment price, or information for promising payment is referred to as payment information.

FIG. 4 is a block diagram illustrating next step to jump from standby step according to an exemplary embodiment of the present invention.

Referring to FIG. 4, when information about an oil kind, a price, and payment to feed fuel exists in fueling information determined at fueling information determining step S1-4, after acceptance of payment is received, the process is jumped to oil feeder setting step S6 of self fueling system step S9. When information to jump to oil feeder setting step S6 is not enough, in order to obtain inefficient information, the process is performed with jump step 5 of standby step 6 formed to jump to predetermined step constituting self fueling system step S9.

At the standby step, when fueling information is received through NFC of the terminal, the gas station system grasps corresponding fueling information and may form a self fueling system to which NFC is applied to jump to a portion of each step of constituting self fueling system step S9.

In this way, at standby step S1 of self fueling system step S9, when an oil kind and a price to feed fuel and payment information are known, an exemplary embodiment showing that can jump to self fueling system step S9 according to a previously programmed procedure is described with reference to the drawing. Further, in this case, at standby step S1, a location S18 to jump to each step is displayed, and in this case, the location S18 to jump may be determined by jump to each step or jump to separate step constituting self fueling system step S9 for helping a configuration of each step.

Here, when a self oil feeder exists at standby step S1 within jump step S1-5, if fueling information is transferred to the self oil feeder through NFC of a mobile device, step jump S1-5 may be performed to step constituting predesignated self fueling system step S9 according to a content of fueling information by deviating from standby step S1.

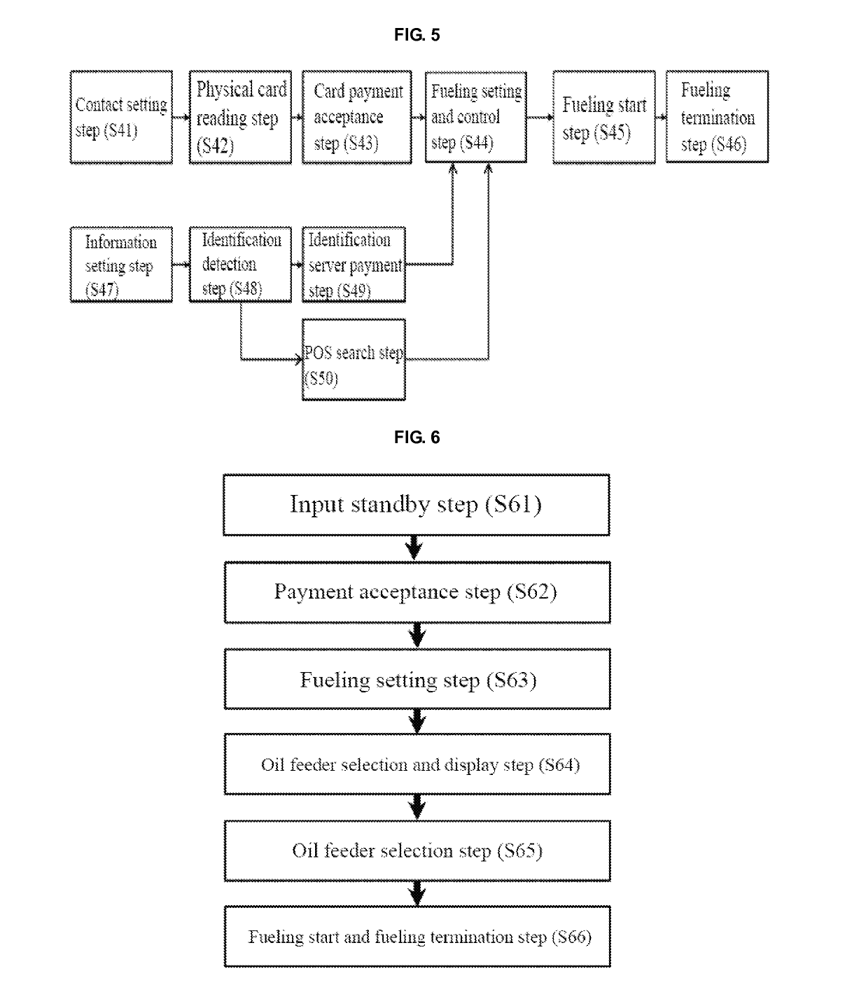

FIG. 5 is a block diagram illustrating a fueling method of using a POS system according to an exemplary embodiment of the present invention.

Referring to FIG. 5, the fueling method includes information setting step S47, identification detection step S48, POS search step S50, identification server payment step S49, fueling setting and control step S44, fueling start step S45, and fueling termination step S46.

The user stores and sets information about an oil kind to feed fuel, a price, and an identification code at a portable payment instrument that can transfer information to the self oil feeder (S47) and transmits the oil kind to feed fuel, the price, and the identification code to the corresponding oil feeder using the portable payment instrument.

It is preferable that the portable payment instrument is a credit card mounted in a portable terminal or a terminal having a communication function.

The stored oil kind information, price information, and identification code is output on a screen as a bar code or an image that can display a fueling oil kind, a price, and an identification code on the screen of the terminal, and a corresponding oil feeder may recognize the bar code or the image.

At the identification detection step S48, the fueling system determines the oil kind information, the price information, and the identification code information and determines whether information of a payment function is included in the identification code information. For example, when transmitting a portion of the identification code to a server of a payment company such as a credit card that can pay, if the fueling price may be accepted, it may be regarded that information of a payment function exists in the identification code. Alternatively, another code symmetrical to the identification code instead of a portion of the identification code is previously stored at the server of the payment company, and even when the server of the payment company accepts such symmetrical another code, it may be assumed that information of a payment function exists.

When information of a payment function exists, at identification server payment step S49, the oil kind information, the price information, and the identification code information is provided, and when information of a payment function does not exist, at POS search step S50, the oil kind information, the price information, and the identification code information is provided.

The identification code includes an attribute of credit card related information for payment or a code that can distinguish a credit customer or organization of a filling station in addition to a code that can identify an attribute of information of a paying person who pays a price to finally feed fuel when feeding fuel.

A meaning of simultaneously receiving the oil kind, the price, and the identification code from a portable payment instrument may indicate that the oil kind, price, and identification code are simultaneously transferred when the oil kind, the price, and the identification code are sequentially transferred until step before identification detection step S48, and if the oil kind, the price, and the identification code to feed fuel are not transmitted, it is preferable that identification detection step S48 is formed to not perform operation.

At the identification server payment step S49, payment is requested to a payment server having information of the identification code and payment acceptance is received (S49).

At the POS search step S50, the POS system analyzes a previously stored identification code and searches for whether fueling is available or unavailable with a content corresponding to the oil kind information and price information, thereby accepting whether to feel fuel. The POS system is interlocked with the self oil feeder and stores an identification code provided to a credit customer in which payment of a credit card is unnecessary and a customer, having performed advance payment for a fueling price, when receiving an identification code from a terminal of a customer in which payment of a credit card is unnecessary, the POS system may search for whether a corresponding identification code is previously stored, analyze whether fueling is available, and accept whether to feel fuel.

When the identification server payment step S49 and identification POS search step S50 are not performed, contact setting step S41 of setting a fueling oil kind and a fueling price by directly contacting with the self oil feeder with a person's hand and physical card reading step S42 of reading a credit card in order to pay a price set at the contact setting step S41, and card payment acceptance step S43 of paying a price set at contact setting step S41 by transferring whether acceptance of card payment using read information at a server of a credit card payment company read at the physical card reading step S42 are performed.

At intermediate step between the contact setting step S41 and card payment acceptance step S43, at identification server payment step 9 and POS search step S50 by identification detection step S43, when a signal enters, intermediate step between contact setting S41 and card payment acceptance step S43 is controlled to initialize. At the identification server payment step S49 and POS search step S50, when the accepted fueling oil kind and price are transferred to a corresponding oil feeder, setting is performed for immediate fueling (S44).

Here, initialization means entrance to standby state as the self oil feeder to previous step of contact setting step S41, even if step from contact setting step S41 to card payment acceptance step S43 is performed, but means that identification detection step S43 is performed while card payment acceptance step S43 is reset from contact setting step S41.

At fueling start step S45, fueling is terminated and an oil feeder gun is fixed to the self oil feeder and thus when fueling is complete, at step of requiring a receipt and a fueling result, information is displayed in a corresponding terminal (S46).

FIG. 6 is a block diagram illustrating a fueling setting method of using a POS terminal in a non-self filling station according to an exemplary embodiment of the present invention.

Referring to FIG. 6, the fueling setting method includes input standby step S61, payment acceptance step S62, fueling setting step S63, oil feeder selection and display step S64, oil feeder selection step S65, and fueling start and fueling termination step S66.

The input device of the POS and the fueling terminal stand by an input of fueling setting request information and payment information from a portable payment instrument in which a fueling oil kind and a fueling price are set (S61).

When selecting a mode of a state that receives information of payment instrument by manipulating the input device of the POS and the fueling terminal, the filling station attendant or a person to feed fuel receives an input of information of the payment instrument in the input device of the POS and the terminal.

The fueling terminal is interlocked with the POS while having a partial function of the fixed POS. The fueling terminal is preferably a terminal having a function of receiving an input of information necessary for fueling payment, but when a POS system does not exist in the filling station, a terminal including a POS function that can determine a request and acceptance of payment of a credit card, which is an essential function of the POS system may be the fueling terminal. In each oil feeder, an intrinsic fueling terminal may be installed.

When setting a fueling oil kind and a fueling price to the payment instrument or when a fueling oil kind and a fueling price are set to the payment instrument and corresponding fueling setting information is transferred through the input device of the POS and the fueling terminal, if the POS system may extract or estimate a fueling oil kind and a fueling price from the transferred information, it may be referred to as fueling setting information. Alternatively, in the POS system, a fueling oil kind and a fueling price may be set with one of the fueling oil kind and the fueling price.

At the input standby step S61, when fueling setting request information and payment information is input, the input device of the POS and the fueling terminal transfer input fueling setting request information and payment information to the POS of the filling station, the POS determines whether payment is accepted using payment information among transferred contents and determines whether the determined payment is accepted (S62).

When acceptance of a price to feed fuel is requested to a server of a payment company that accepts payment with the provided payment information and a price to feed fuel, the server of the payment company determines contents of payment information, and when it is determined that a request for payment acceptance is available, the server of the payment company accepts payment and transmits the accepted content to the POS. In this case, as a kind of payment companies, there are a card company, a mileage company, and a mobile phone communication company, and the payment company is a payment company that can pay a price for fueling, but when there is a company that performs trade on credit, a server that accepts credit is also a payment company. For example, payment information having information of a credit card together with a price to feed fuel is transferred to a server of a card payment company of the credit card, and the server of the card payment company analyzes payment information and grasps a credit limit of a card owner having payment information, and when the price to feed fuel exists within a credit limit range, the server confirms acceptance of a price to feed fuel and transmits an acceptance number to the POS.

At the payment acceptance step S62, when acceptance of payment is determined, a fueling oil kind and a fueling price are set to correspond to fueling setting request information to the oil feeder to feed fuel (S63).

Among the fueling setting request step S63 starting from step before the input standby step 1, at a previous step of setting a fueling oil kind and a fueling price to the oil feeder, a screen having a predetermined menu that can select the oil feeder to feed fuel is displayed in the fueling terminal and the input device of the POS (S64).

At the input device of the POS and a menu of the fueling terminal, by forming a button that can select and input the oil feeder, it is preferable to form to select and input a corresponding oil feeder, but a button of the oil feeder may be formed and selected at a touch monitor of the POS or a touch monitor of the fueling terminal (S65). In this case, in order to select using the input device of the POS and a keypad of the fueling terminal, an oil feeder may be displayed to input at each monitor. In this case, in the payment instrument, when information about the oil feeder to feed fuel exists, information about the oil feeder may be input at input standby step S61 and information about the oil feeder to feed fuel may exist from input standby step 1. Here, at step before setting a fueling oil kind and a fueling price to the oil feeder, when actually setting the fueling oil kind and the fueling price, an oil feeder as a subject that should perform setting should be selected, and setting is performed by interlocking with another program before input standby step S61, and in this case, upon interlocking, when the oil feeder is selected, oil feeder selection and display step S64 and oil feeder selection step S65 may not be performed. After the input standby step S61, when information about the oil feeder is transferred with interlock of another input device and input instrument or another program, oil feeder selection and display step S64 and oil feeder selection step S65 may not performed. That is, a case of automatically recognizing the oil feeder, as the oil feeder sends a signal thereof, and when the POS requests fueling payment or receives a request for fueling payment, an input of information about an oil feeder to feed fuel may be received from an external server. At previous step of setting a fueling oil kind and a fueling price, when forming a menu of selecting the oil feeder, a menu that can select the oil feeder at each step may be always input. Therefore, at each step, an oil feeder number may be input at any time. In the input device of the POS and a touch monitor of the fueling terminal, information about the oil feeder is displayed, and the oil feeder may be selected with a method of touching the displayed information. The oil feeder may be selected using an abbreviated number of a separate keypad. Further, at previous step of setting a fueling oil kind and a fueling price, when the oil feeder is not selected, it may be requested to input a number of the oil feeder. Even if an oil feeder number is not selected, the oil feeder automatically receives information about the fueling terminal due to a separate transmitting and receiving device installed in the oil feeder and in order for the filling station attendant to feed fuel, when the filling station attendant selects or presses a specific button of the oil feeder, the fueling terminal may read information and thus the oil feeder may be selected. In this case, even if a separate device is not installed, in the fueling terminal or the input device of the POS, at step before operating the oil feeder, the filling station attendant provides a code that can identify, by directly inputting a code that can identify by moving to a corresponding oil feeder or by using an indirect device, the oil feeder can be selected.

When the preset oil feeder is operated to feed fuel due to the fueling setting step S63, fueling is performed using the operated oil feeder, and when fueling is terminated, if a fueling price set at fueling setting step S63 and an actual fueling price are different, reacceptance is performed with the actual fueling price and if a fueling price set at fueling setting step S63 and an actual fueling price are not different, fueling is terminated (S66).

In this way, in the present invention, a method of automatically fueling using wireless communication in a system including a wireless terminal and an oil feeder and a fueling system that receive a wireless signal from the wireless terminal includes: selecting at least one of oil kind information, price information, payment information, and oil feeder information in the wireless terminal and storing the selected at least one oil kind information, price information, and payment information; transmitting, by the wireless terminal, the at least one oil kind information, price information, and payment information to the selected oil feeder or the fueling system by wireless, when the wireless terminal approaches an oil feeder or fueling system area; and automatically fueling setting to the oil feeder or the fueling system based on the oil kind information, price information, and payment information.

When transmitting by wireless, if only payment information is transmitted to the oil feeder or the fueling system, the oil feeder or the fueling system previously stores the payment information and is set based on oil kind information and price information matched to the payment information.

When transmitting by wireless, a Near Field Communication (NFC) protocol is used.

Preferably, the oil feeder or the fueling system determines the transmitted at least one oil kind information, price information, and payment information; the oil feeder or the fueling system requests a user to select at least one of oil kind information, price information, and payment information, when at least one information of the transmitted oil kind information, price information, and payment information is not transmitted or when an error has occurred when transmitting information; the oil feeder or the fueling system pays based on the transmitted oil kind information, price information, and payment information or the oil kind information, price information, and payment information transmitted by the request; and the oil feeder or the fueling system feeds fuel based on the preset oil kind information, price information, and an acceptance result.

In the oil feeder or the fueling system, at the paying of paying based on the transmitted oil kind information, price information, and payment information, when fueling information, price information, and payment information is transmitted, if the previously transmitted fueling information, price information, and payment information and the transmitted fueling information, price information, and payment information are different, a priority is determined, the fueling information, price information, and payment information is adjusted, or different any one is disregarded.

In the oil feeder or the fueling system, when a user selects at least one of oil kind information, price information, and payment information according to the request, the oil feeder or the fueling system blocks information from being injected from the outside.

When only the price information is transmitted, fueling is performed based on previously stored oil kind information and payment information.

When only the oil kind information is transmitted, fueling is performed based on previously stored price information and payment information.

The oil feeder or the fueling system automatically sets fueling based on the oil kind information, price information, and payment information, if the transmitted at least one oil kind information, price information, and payment information exists.

Preferably, the wireless terminal, the oil feeder, and the fueling system activate a near field communication protocol (NFC protocol), and the wireless terminal transmits previously stored oil kind information, price information, and payment information to the oil feeder or the fueling system using the activated NFC protocol without a user's selection process, and the oil feeder or the fueling system accepts payment based on the previously stored oil kind information, price information, and payment information received through the NFC protocol, and when at least one information of previously stored oil kind information, price information, and payment information transmitted through the NFC protocol is not transmitted or when an error has occurred, the oil feeder or the fueling system requests the user to select at least one of the oil kind information, the price information, and the payment information.

The requested at least one oil kind information, price information, and payment information is transmitted through the activated NFC protocol.

In the wireless terminal, information about a mileage card, discount information, and coupon information is transmitted through the activated NFC protocol.

In the wireless terminal, at least one information of a fueling pattern, the number of gas station visit, and an average fueling amount of a customer is transmitted through the activated near field communication protocol. In the wireless terminal, it is preferable that the wireless terminal selects an oil feeder by at least one of scanning of an oil feeder having an image or a bar code that can scan at a near distance, display of disposition of at least one oil feeder on a screen, a user's direct selection of an oil feeder identifier formed with a number or a code, or reception and selection of an oil feeder identifier formed with a number or a code that can select from the fueling system.

It is preferable that.

The payment information includes at least one of a mobile phone number, an IP address, an Internet account, and a credit card number, and the oil feeder or the fueling system previously stores the payment information, and when only the payment information is transmitted from the wireless terminal, oil kind information and price information matched to the payment information is set to the oil feeder.

The wireless terminal stores the selected at least one oil kind information, price information, and payment information in a form of at least one of a character code, a bar code, and a QR code, and when the wireless terminal approaches the oil feeder or the fueling system area, the stored payment information is transmitted from the wireless terminal to the oil feeder or the fueling system with an infrared ray communication protocol method.

The selected at least one oil kind information, price information, and payment information is stored at a subscriber identity module chip, an NFC chip, and an RFID chip of a credit card.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

By enabling an oil kind and a fueling price to automatically set using a wireless communication function of a terminal, a problem of fuel mixing that feeds another oil kind can be prevented and thus the present invention is technology having high industrial applicability.

The present invention is technology having high industrial applicability that can conveniently apply to a self oil feeder using a wireless communication function of a terminal when using the self oil feeder.

1. A method of automatically fueling using wireless communication in a system comprising a wireless terminal and an oil feeder and a fueling system that receive a wireless signal from the wireless terminal, the method comprising:
selecting at least one of oil kind information, price information, payment information, and oil feeder information in the wireless terminal and storing the selected at least one oil kind information, price information, and payment information;
transmitting, by the wireless terminal, the at least one oil kind information, price information, and payment information to the selected oil feeder or the fueling system by wireless, when the wireless terminal approaches an oil feeder or fueling system area; and
automatically fueling setting to the oil feeder or the fueling system based on the oil kind information, price information, and payment information.

2. The method of claim 1, wherein at the transmitting of the at least one oil kind information, when only payment information or identification code information is transmitted to the oil feeder or the fueling system, the oil feeder or the fueling system previously stores the payment information or identification code information and the oil feeder or the fueling system is set based on oil kind information and price information matched to the payment information or identification code information.

3. The method of claim 1, further comprising:
determining, by the oil feeder or the fueling system, the transmitted at least one oil kind information, price information, and payment information;
requesting, by the oil feeder or the fueling system, a user to select at least one of oil kind information, price information, and payment information, when at least one information of the transmitted oil kind information, price information, and payment information is not transmitted or when an error has occurred when transmitting information;
paying, by the oil feeder or the fueling system, based on the transmitted oil kind information, price information, and payment information or the oil kind information, price information, and payment information transmitted by the request; and
fueling, by the oil feeder or the fueling system, based on the preset oil kind information, price information, and an acceptance result.

4. The method of claim 3, wherein in the oil feeder or the fueling system, at the paying of based on the transmitted or transmitted oil kind information, when fueling information, price information, and payment information is transmitted, if the previously transmitted fueling information, price information, and payment information and the transmitted fueling information, price information, and payment information are different, a priority is determined, the fueling information, price information, and payment information is adjusted, or different any one is disregarded.

5. The method of claim 3, wherein the oil feeder or the fueling system automatically sets fueling based on the oil kind information, price information, and payment information, if the transmitted at least one oil kind information, price information, and payment information exists.

6. The method of claim 1, wherein the wireless terminal selects an oil feeder by at least one of scanning of an oil feeder having an image or a bar code that can scan at a near distance, display of disposition of at least one oil feeder on a screen, a user's direct selection of an oil feeder identifier formed with a number or a code, or reception and selection of an oil feeder identifier formed with a number or a code that can select from the fueling system.

7. The method of claim 1, wherein the wireless terminal stores the selected at least one oil kind information, price information, and payment information in a form of at least one of a character code, a bar code, and a QR code, and when the wireless terminal approaches the oil feeder or the fueling system area, the stored payment information is transmitted from the wireless terminal to the oil feeder or the fueling system with an infrared ray communication protocol method.
